(19) United States
(12) Patent Application Publication
(10) Pub. No.: US 2009/0016625 A1
(43) Pub. Date: Jan. 15, 2009

(54) IMAGING APPARATUS AND METHOD OF IMPROVING SENSITIVITY OF THE SAME

(75) Inventors: Il-do KIM, Seoul (KR); Jae-Sung Jun, Seoul (KR); Byung-Sun Choi, Gunpo-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/020,597

(22) Filed: Jan. 28, 2008

(30) Foreign Application Priority Data
Jul. 10, 2007 (KR) 10-2007-0069212

(51) Int. Cl. G06K 9/36; G06K 9/40

(52) U.S. Cl. 382/238; 382/263

(57) ABSTRACT

An imaging apparatus and a method improving the sensitivity of the imaging apparatus are provided. The imaging apparatus includes a pixel binning unit pixel binning input image data to a given pixel size; a gain determining unit determining a pixel binning gain based on the input image data or the brightness of the input image data; and a calculating unit calculating output image data based on the pixel binned input image data and the pixel binning gain. Accordingly, the resolution of input image data can be preserved and the dynamic range of an image signal under low illumination conditions can be expanded.

### CROSS-REFERENCE TO RELATED PATENT APPLICATION

This application claims priority from Korean Patent Application No. 10-2007-0069212, filed on Jul. 10, 2007, in the Korean Intellectual Property Office, the disclosure of which is incorporated herein in its entirety by reference.

### BACKGROUND OF THE INVENTION

1. Field of the Invention

Apparatus and methods consistent with the present invention relate to an imaging apparatus and a method of improving the sensitivity of the same, and more particularly, to an imaging apparatus, which can improve image data sensitivity under low illumination conditions and prevent noise, and a method of improving the sensitivity of the imaging apparatus.

2. Description of the Related Art

Imaging apparatuses, such as cameras or camcorders, convert light of an image into an electric signal, using an imaging device such as a complementary metal-oxide semiconductor (CMOS) or a charge-coupled device (CCD).

Ideally, imaging devices produce an electric signal in proportion to the amount of incident light. However, various kinds of noise are generated when light is converted into an electric signal. Such noise includes dark current noise, kTC noise, and fixed pattern noise.

Dark current noise, which is thermal noise proportional to the temperature, is a major factor in image quality degradation under low illumination conditions. kTC noise is generated by various switching pulses that are used to drive a CMOS or a CCD camera. Fixed pattern noise results from non-uniformity caused by manufacturing variations between pixels in an imaging device, such as a CMOS or a CCD. Fixed pattern noise includes a white spot defect, a black spot defect, a line defect, a banded defect, and a sensitivity speck. Such noise is added to charges which are photoelectrically converted and accumulated by the imaging device, thereby degrading image quality.

Under high illumination conditions with a great amount of light, since noise is relatively small compared to photoelectrically converted and accumulated charges, image quality degradation is negligible. However, under low illumination conditions, fixed pattern noise, dark current noise, and kTC noise become greater than photoelectrically converted and accumulated charges.

In order to make photoelectrically converted and accumulated charges larger than noise under low illumination conditions, an imaging device having a large pixel pitch may be used, or the exposure time of an imaging device may be increased. However, the imaging device having the large pixel pitch is expensive and the size of the imaging device should be increased to provide the same resolution.

### SUMMARY OF THE INVENTION

The present invention provides an imaging apparatus, which can preserve resolution and can also expand the dynamic range of an image signal under low illumination conditions by increasing the power of an output image signal in comparison to the power of noise, and a method of improving the sensitivity of the imaging apparatus.

The present invention also provides an imaging apparatus, which can improve sensitivity by preventing noise boost-up, and a method of improving the sensitivity of the imaging apparatus.

According to an aspect of the present invention, there is provided an imaging apparatus comprising: a pixel binning unit pixel binning input image data to a given pixel size; a gain determining unit determining a pixel binning gain based on the input image data or the brightness of the input image data; and a calculating unit calculating output image data based on the pixel binned input image data and the pixel binning gain.

The pixel binning unit may preserve the resolution of the input image data.

The gain determining unit may determine the pixel binning gain as a given maximum gain when the brightness of the input image data is less than a first threshold, and determine the pixel binning gain as a gain, which linearly decreases from the given maximum gain as the brightness of the input image data increases, when the brightness of the input image data is greater than the first threshold.

The calculating unit may calculate the output image data by multiplying the pixel binned input image data by the pixel binning gain.

The imaging apparatus may further comprise a temporal expansion unit expanding the dynamic range of the output image data based on current frame data and previous frame data of the output image data.

The gain determining unit may determine a data merge gain of the temporal expansion unit and provide the data merge gain to the temporal expansion unit.

According to another aspect of the present invention, there is provided an imaging apparatus comprising: a pixel binning unit pixel binning input image data to a given pixel size; a high pass filtering unit filtering high frequency components in a plurality of directions of the input image data; a resolution preserving factor determining unit determining a resolution preserving factor based on the high frequency components; and a calculating unit calculating output image data based on the pixel binned input image data, the high frequency components, and the resolution preserving factor.

The high pass filtering unit may comprise: a horizontal high pass filter filtering a first high frequency component in a horizontal direction of the input image data; and a vertical high pass filter filtering a second high frequency component in a vertical direction of the input image data.

The high pass filtering unit may further comprise a diagonal high pass filter filtering a third high frequency component in a diagonal direction of the input image data.

The resolution preserving factor determining unit may: obtain a maximum absolute value among absolute values of a difference between the first and second high frequency components, a difference between the second and third high frequency components, and a difference between the first and third high frequency components; determine the resolution preserving factor as a given minimum factor when the maximum absolute value is less than or equal to a second threshold; determine the resolution preserving factor as a given maximum factor when the maximum absolute value is greater than or less than a third threshold; and determine the resolution preserving factor as a gain, which linearly increases as the maximum absolute value increases between the minimum factor and the maximum factor, when the maximum absolute value is between the second threshold and the third threshold.

The calculating unit may calculate the output image data by multiplying a sum of the high frequency components by the resolution preserving factor and adding the pixel binned input image data to the multiplication result.

The imaging apparatus may further comprise a temporal expansion unit expanding the dynamic range of the output image data based on current frame data and previous frame data of the output image data.

According to another aspect of the present invention, there is provided a method of improving the sensitivity of an imaging apparatus, the method comprising: pixel binning input image data to a given pixel size; determining a pixel binning gain based on the input data or the brightness of the input image data; and calculating output image data based on the pixel binned input image data and the pixel binning gain.

According to another aspect of the present invention, there is provided a method of improving the sensitivity of an imaging apparatus, the method comprising: pixel binning input image data to a given pixel size; filtering high frequency components in a plurality of directions of the input image data; determining a resolution preserving factor based on the high frequency components; and calculating output image data based on the pixel binned input image data, the high frequency components, and the resolution preserving factor.

According to another aspect of the present invention, there is provided a computer-readable recording medium having embodied thereon a program for implementing a method of improving the sensitivity of an imaging apparatus, wherein the method comprises: pixel binning input image data to a given pixel size; determining a pixel binning gain based on the input image data or the brightness of the input image data; and calculating output image data based on the pixel binned input image data and the pixel binning gain.

According to another aspect of the present invention, there is provided a computer-readable recording medium having embodied thereon a program for implementing a method of improving the sensitivity of an imaging apparatus, wherein the method comprises: pixel binning input image data to a given pixel size; filtering high frequency components in a plurality of directions of the input image data; determining a resolution preserving factor based on the high frequency components; and calculating output image data based on the pixel binned input image data, the high frequency components, and the resolution preserving factor.

### BRIEF DESCRIPTION OF THE DRAWINGS

The above and other aspects of the present invention will become more apparent by describing in detail exemplary embodiments thereof with reference to the attached drawings, in which:

FIG. 1 is a block diagram of an imaging apparatus according to an exemplary embodiment of the present invention;

FIG. 2 is a block diagram of an imaging apparatus according to another exemplary embodiment of the present invention;

FIG. 3 is a block diagram of an imaging apparatus according to another exemplary embodiment of the present invention;

FIG. 4 is a block diagram of an imaging apparatus according to another exemplary embodiment of the present invention;

FIGS. 5A through 5E illustrate pixels for explaining pixel binning for preserving the resolution of input image data, according to an exemplary embodiment of the present invention;

FIG. 6 is a graph for explaining a process of determining a resolution preserving factor according to an exemplary embodiment of the present invention;

FIG. 7 is a graph for explaining a process of determining a pixel binning gain according to an exemplary embodiment of the present invention;

FIG. 8A is a block diagram of a temporal expansion unit according to an exemplary embodiment of the present invention;

FIG. 8B is a graph for explaining a process of determining a ratio at which current frame data and previous frame data merge with each other according to an exemplary embodiment of the present invention;

FIG. 9 is a flowchart illustrating a method of improving the sensitivity of an imaging apparatus according to an exemplary embodiment of the present invention;

FIG. 10 is a flowchart illustrating a method of improving the sensitivity of an imaging apparatus according to another exemplary embodiment of the present invention; and

FIG. 11 is a flowchart illustrating a method of improving the sensitivity of an imaging apparatus according to another exemplary embodiment of the present invention.

### DETAILED DESCRIPTION OF EXEMPLARY EMBODIMENTS

The present invention will now be described more fully with reference to the accompanying drawings, in which exemplary embodiments of the invention are shown.

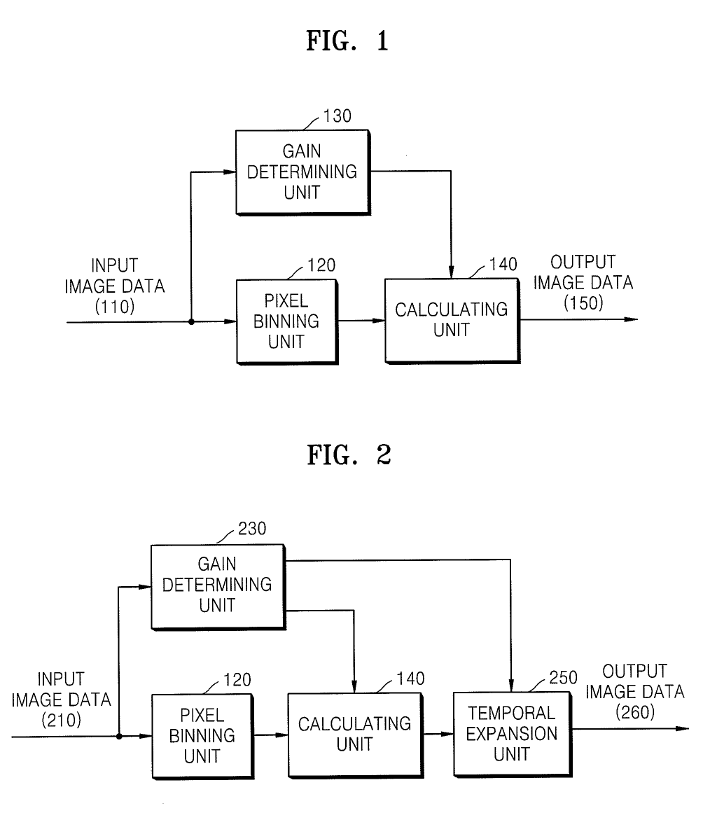

FIG. 1 is a block diagram of an imaging apparatus according to an exemplary embodiment of the present invention.

Referring to FIG. 1, the imaging apparatus includes a pixel binning unit 120, a gain determining unit 130, and a calculating unit 140.

The pixel binning unit 120 pixel bins input image data 110 to a predetermined pixel size, for example, 2×2 or 3×3. A plurality of pixel data adjacent to one pixel are combined into one pixel data. Since pixel binning is a process of combining data of a plurality of pixels into data of one pixel, sensitivity can be improved but resolution is reduced under low illumination conditions.

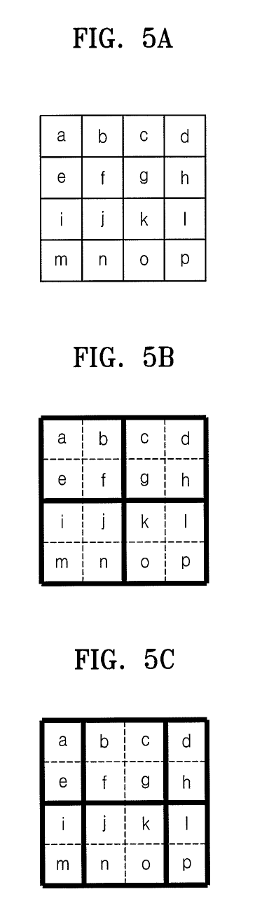

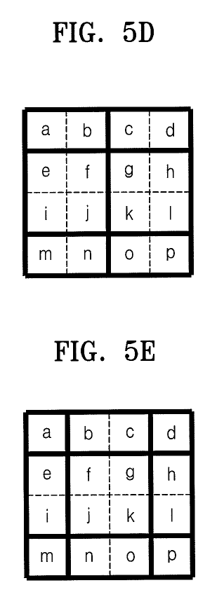

However, the pixel binning unit 120 of the imaging apparatus of FIG. 1 pixel bins the input image data 110 in a horizontal or vertical direction while preserving resolution of the input image data 110, which will be explained with reference to FIGS. 5A through 5E.

FIG. 5A illustrates pixels ‘a’, ‘b’, ‘c’, . . . ‘p’ before pixel binning.

FIG. 5B is a view for explaining a 2×2 pixel binning process of obtaining pixel binned data for the pixels ‘a’, ‘c’, ‘i’, and ‘k’. Pixel binned data for the pixel ‘a’ can be obtained by summing up input image data for the pixels ‘a’, ‘b’, ‘e’, and ‘f’. Pixel binned data for the pixel ‘c’ can be obtained by summing up input image data for the pixels ‘c’, ‘d’, ‘g’, and ‘h’. Pixel binned data for the pixels ‘i’ and ‘k’ can be obtained in the same manner.

Likewise, FIG. 5C is a view for explaining a 2×2 pixel binning process of obtaining pixel binned data for the pixels ‘b’, ‘d’, ‘j’, and ‘l’. For example, input image data for the pixel ‘b’ can be obtained by summing up input image data for the pixels ‘b’, ‘c’, ‘f’, and ‘g’. Input image data for the pixel ‘d’ can be obtained by summing up input image data for the pixels ‘d’, ‘a’, ‘h’, and ‘e’. Input image data for the pixel ‘l’ can be obtained by summing up input image data for the pixels ‘l’, ‘i’, ‘p’, and ‘m’.

FIG. 5D is a view for explaining a 2×2 pixel binning process of obtaining pixel binned data for the pixels ‘e’, ‘g’, ‘m’, and ‘o’. FIG. 5E is a view for a pixel binning process of obtaining pixel binned data for the pixels ‘f’, ‘h’, ‘n’, and ‘p’.

In this manner, input image data for all pixels ‘a’, ‘b’, ‘c’, . . . ‘p’ can be obtained. Accordingly, the pixel binning of FIGS. 5A through 5E can improve sensitivity under low illumination conditions while preserving the resolution. Although the pixel binning preserves the resolution in FIGS. 5A through 5E, the present exemplary embodiment is not limited thereto and the pixel binning may be performed while reducing the resolution.

Referring to FIG. 1 again, the gain determining unit 130 determines a pixel binning gain based on the input image data 110 or the brightness of the input image data 110. The pixel binning gain is a gain of data output from the pixel binning unit 120. For example, output image data 150 may be calculated by the calculating unit 140 as a multiplication of an output of the pixel binning unit 120 and the pixel binning gain.

FIG. 7 is a graph illustrating a relationship between the pixel binning gain and the input image data 110 or the brightness of the input image data 110. For example, when the brightness of the input mage data 110 is less than a first threshold, the gain determining unit 130 may determine the pixel binning gain as a predetermined maximum gain, and when the brightness of the input image data 110 is greater than the first threshold, the gain determining unit 130 may determine the pixel binning gain as a gain which linearly decreases from the maximum gain as the brightness of the input image data increases. The maximum gain and the gradient of the pixel binning gain may be varied according to exemplary embodiments.

The calculating unit 140 calculates the output image data 150 based on the pixel binned image data output from the pixel binning unit 120 and the pixel binning gain output from the gain determining unit 130. Although the calculating unit 140 is shown to calculate the output image data 150 by multiplying the output of the pixel binning unit 120 by the pixel binning gain in FIG. 1, the present exemplary embodiment is not limited thereto.

According to the imaging apparatus of FIG. 1, when the brightness of the input image data 110 is low, a dynamic range can be increased by improving the sensitivity of the imaging apparatus.

FIG. 2 is a block diagram of an imaging apparatus according to another exemplary embodiment of the present invention.

Referring to FIG. 2, the imaging apparatus includes a pixel binning unit 120, a gain determining unit 230, a calculating unit 140, and a temporal expansion unit 250.

Since the pixel binning unit 120 and the calculating unit 140 are the same as those of FIG. 1, a detailed explanation thereof will not be given.

The temporal expansion unit 250 expands the dynamic range of output image data 260 based on current frame data and previous frame data of image data output from the calculating unit 140.

The gain determining unit 230 determines a pixel binning gain, and also determines a data merge gain, which is a ratio at which the current frame data and the previous frame data merge with each other, and provides the determined data merge gain to the temporal expansion unit 250. The ratio at which the current frame data and the previous frame data are merged with each other may be varied depending on a motion between frames.

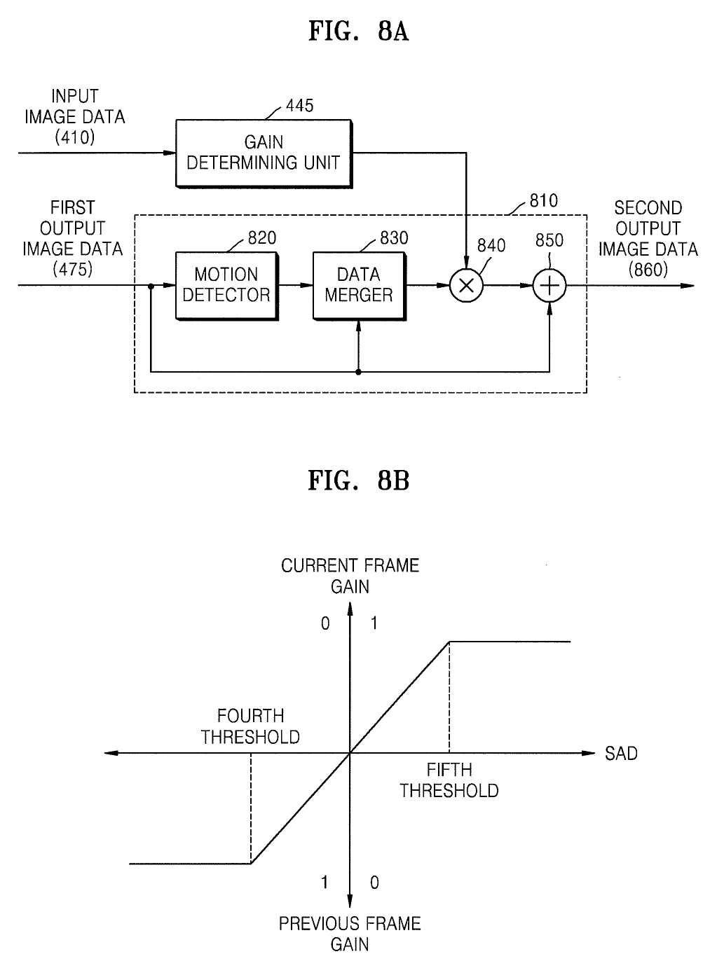

The gain determining unit 230 and the temporal expansion unit 250 will be explained later in detail with reference to FIGS. 8A and 8B.

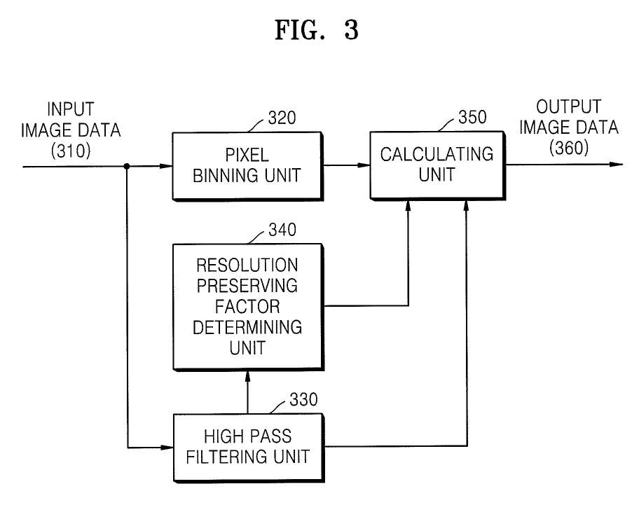

FIG. 3 is a block diagram of an imaging apparatus according to another exemplary embodiment of the present invention.

Referring to FIG. 3, the imaging apparatus includes a pixel binning unit 320, a high pass filtering unit 330, a resolution preserving factor determining unit 340, and a calculating unit 350.

The pixel binning unit 320 pixel bins input image data to a predetermined pixel size. The pixel binning unit 320 can preserve the resolution of input image data 310.

The high pass filtering unit 330 filters high frequency components in a plurality of directions of the input image data 310. The filtering of the high frequency components in the plurality of directions comprises judging whether a high frequency component of a pixel is generated by an image or a noise. In general, when there is a high frequency component in a certain direction, existence of an edge in the direction can be detected. Accordingly, if all high frequency components filtered in horizontal, vertical, and diagonal directions of one pixel have high values, the one pixel may be detected as a noise.

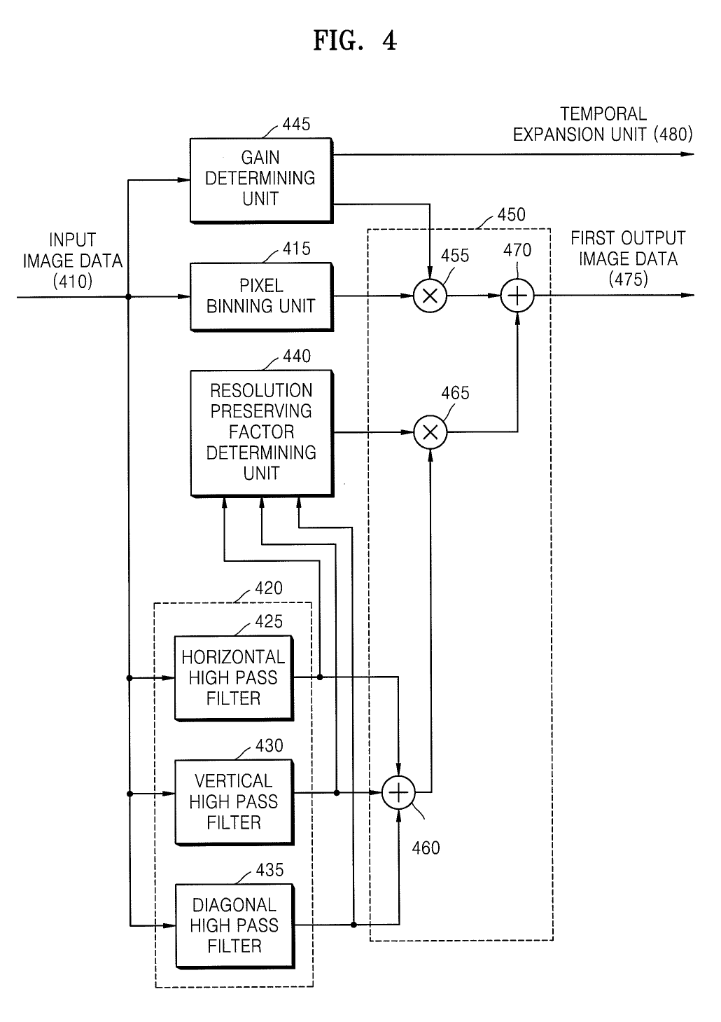

The resolution preserving factor determining unit 340 determines a resolution preserving factor based on the high frequency components. If the high pass filtering unit 330 judges that a high frequency component of a pixel is generated by an image, the resolution preserving factor determining unit 340 determines the resolution preserving factor to maintain the high frequency component, whereas if the high pass filtering unit 330 judges that the high frequency component of the pixel is generated by a noise, the resolution preserving factor determining unit 340 determines the resolution preserving factor not to maintain the high frequency component. The resolution preserving factor determining unit 340 will be explained later with reference to FIG. 4.

The calculating unit 350 calculates output image data 360 based on the pixel binned input image data, the high frequency components, and the resolution preserving factor.

FIG. 4 is a block diagram of an imaging apparatus according to another exemplary embodiment of the present invention.

Referring to FIG. 4, the imaging apparatus includes a pixel binning unit 415, a high pass filtering unit 420, a resolution preserving factor determining unit 440, a gain determining unit 445, and a calculating unit 450.

The pixel binning unit 415 pixel bins input image data 410 to a predetermined pixel size. The pixel binning unit 415 preserves the resolution of input image data 410.

The high pass filtering unit 420 includes a horizontal high pass filter 425, a vertical high pass filter 430, and a diagonal high pass filter 435.

The horizontal high pass filter 425 filters a first high frequency component ‘H_hpf’ in a horizontal direction of the input image data 410. The vertical high pass filter 430 filters a second high frequency component ‘V_hpf’ in a vertical direction of the input image data 410. The diagonal high pass filter 435 filters a third high frequency component ‘D_hpf’ in a diagonal direction of the input image data 410.

In modifications, the high pass filtering unit 420 may include only two filtering units, e.g., the horizontal high pass filter 425 and the vertical high pass filter 430, or may include four or more filtering units.

The resolution preserving factor determining unit 440 calculates the absolute value |H_hpf−V_hpf| of a difference between the first and second high frequency components H_hpf and V_hpf, the absolute value |V_hpf−D_hpf| of a difference between the second and third high frequency components V_hpf and D_hpf, and the absolute value |H_hpf−D_hpf| of a difference between the first and third high frequency components H_hpf−D_hpf. Next, the resolution preserving factor determining unit 440 obtains a maximum Diff_Max, which is the largest of the three absolute values. That is, the maximum Diff_Max is given by ‘Diff_Max=max(|H_hpf−V_hpf|, |V_hpf−D_hpf|, |H_hpf−D_hpf|)’.

Next, the resolution preserving factor determining unit 440 determines a resolution preserving factor based on the obtained maximum Diff_Max.

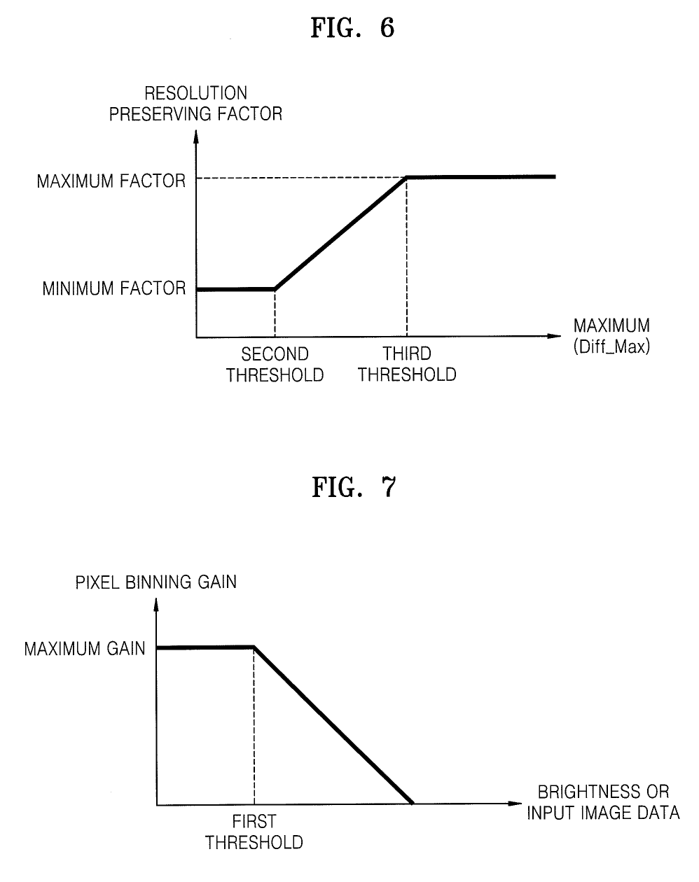

FIG. 6 is a graph for explaining a process of determining a resolution preserving factor according to an exemplary embodiment of the present invention.

Referring to FIG. 6, when the maximum Diff_Max is less than or equal to a second threshold, the resolution preserving factor is determined as a predetermined minimum factor. When the maximum Diff_Max is greater than or equal to a third threshold, the resolution preserving factor is determined as a predetermined maximum factor. When the maximum Diff_Max is between the second threshold and the third threshold, the resolution preserving factor is determined as a gain which linearly increases as the maximum Diff_Max increases between the minimum factor and the maximum factor. This is because generally a noise component has a small maximum Diff_Max and an image component has a large maximum Diff_Max.

Referring to FIG. 4 again, the gain determining unit 445 determines a pixel binning gain based on the input image data 410 or the brightness of the input image data 410. The pixel binning gain is a gain of data output from the pixel binning unit 415.

FIG. 7 illustrates a relationship between the pixel binning gain and the input image data 410 or the brightness of the input image data 410. The gain determining unit 445 determines the pixel binning gain as a maximum gain when the brightness of the input image data 410 is less than a first threshold, and determines the pixel binning gain as a gain, which linearly decreases from the maximum gain as the brightness of the input image data increases, when the brightness of the input image data 410 is greater than the first threshold. The maximum gain and the gradient of the pixel binning gain may be varied according to exemplary embodiments.

The gain determining unit 445 also determines a data merge gain, which is a ratio at which current frame data and previous frame data are merged with each other, from first output image data 475, and provides the determined data merge gain to a temporal expansion unit 480. Accordingly, both spatial and temporal gains can be adjusted.

The calculating unit 450 includes a first multiplier 455, a second multiplier 465, a first adder 460, and a second adder 470.

The first multiplier 455 multiplies input image data Data_BI pixel binned by the pixel binning unit 415 by a pixel binning gain Expansion_gain_S determined by the gain determining unit 445.

The first adder 460 calculates a sum SHF(=H_hpf+V_hpf+D_hpf) of high frequency components.

The second multiplier 465 multiplies the sum SHF of the high frequency components by a resolution preserving factor RP_factor determined by the resolution preserving factor determining unit 440.

The second adder 470 adds an output of the first multiplier 455 to an output of the second multiplier 465.

That is, first output image data Data_Out_S 475, which is an output of the calculating unit 450, is given by ‘Data_Out_S=Data_BI*Expansion_gain_S+RP_factor*SHF’.

The first output image data 475 may be input to the temporal expansion unit 480 again.

FIG. 8A is a block diagram of a temporal expansion unit 810 according to an exemplary embodiment of the present invention.

The temporal expansion unit 810 includes a motion detector 820, a data merger 830, a third multiplier 840, and a third adder 850.

The motion detector 820 detects a motion between current frame data and previous frame data.

The data merger 830 merges current frame data with previous frame data of first output image data 475 at a predetermined ratio based on the motion detected by the motion detector 820.

FIG. 8B is a graph for explaining a process of determining a ratio at which current frame data and previous frame data merge with each other according to an exemplary embodiment of the present invention.

Referring to FIG. 8B, a ratio at which current frame data Data_curr and previous frame data Data_prev are merged with each other may be determined based on the degree of motion detected by the motion detector 820, for example, based on a sum of absolute differences (SAD).

The SAD, which is a sum (in blocks) of differences between current frame data (or the brightness of the current frame data) and previous frame data (or the brightness of the previous frame data), can be used to judge the degree of motion as well. That is, it is judged that the degree of motion increases as the SAD increases, and the degree of motion decreases as the SAD decreases.

When the SAD is greater than a fifth threshold, a current frame gain Curr_gain is set to “1”, and a previous frame gain Prev_gain is set to “0”. When the SAD is less than a fourth threshold, the current frame gain Curr_gain is set to “0”, and the previous frame gain Prev_gain is set to “1”. In other words, when the SAD is high, an output of the data merger 830 is determined by current frame data, and when the SAD is low, an output of the data merger 830 is determined by previous frame data.

In short, an output Data_merge of the data merger 830 may be defined by ‘Data_merge=Curr_gain*Data_curr+Prev_gain*Data_prev’.

Referring to FIG. 8A, the gain determining unit 445 determines a data merge gain Expansion_gain_T, and outputs the same to the third multiplier 840. The data merge gain Expansion_gain_T, which is determined depending on the input image data 410 or the brightness of the input image data 410, is used to calculate second output image data 860 which will be explained later. The data merge gain Expansion_gain_T may be determined in a similar manner to that used to determine the pixel binning gain of FIG. 7.

The third multiplier 840 multiplies the data merge gain Expansion_gain_T by the output Data_merge of the data merger 830.

The third adder 850 adds an output of the third multiplier 840 to the current frame data Data_curr.

As a result, the second output image data Data_Out may be defined by ‘Data_Out=Data_curr+Expansion_gain_T*Data_merge’.

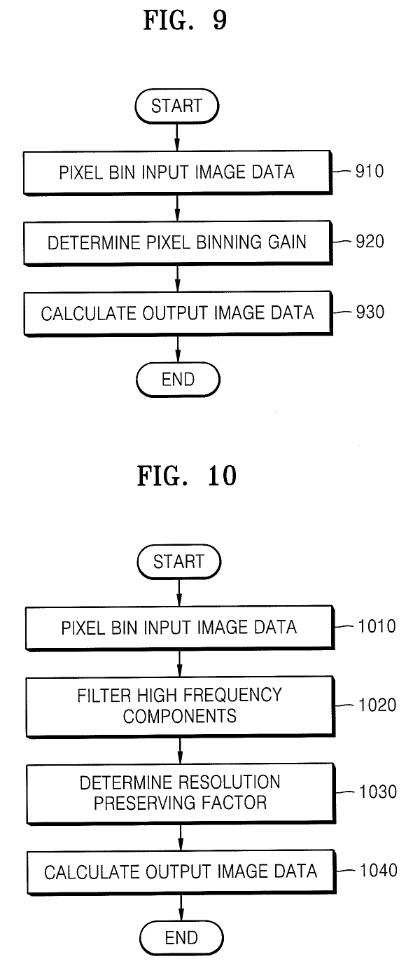

FIG. 9 is a flowchart illustrating a method of improving the sensitivity of an imaging apparatus according to an exemplary embodiment of the present invention.

In operation 910, input image data is pixel binned to a predetermined pixel size. The pixel binning can preserve the resolution of the input image data.

In operation 920, a pixel binning gain is determined based on the input image data or the brightness of the input image data. Since the pixel binning gain has already been described with reference to FIG. 7, a detailed explanation thereof will not be given.

In operation 930, output image data is calculated based on the pixel binned input image data and the pixel binning gain.

FIG. 10 is a flowchart illustrating a method of improving the sensitivity of an imaging apparatus according to another exemplary embodiment of the present invention.

In operation 1010, input image data is pixel binned to a predetermined pixel size.

In operation 1020, high frequency components in a plurality of directions of the input image data are filtered. For example, a first high frequency component in a horizontal direction of the input image data, a second high frequency component in a vertical direction of the input image data, and a third high frequency component in a diagonal direction of the input image data may be filtered.

In operation 1030, a resolution preserving factor is determined based on the high frequency components. Since the resolution preserving factor has already been explained with reference to FIG. 6, a detailed explanation thereof will not be given.

In operation 1040, output image data is calculated based on the pixel binned input image data, the high frequency components, and the resolution preserving factor.

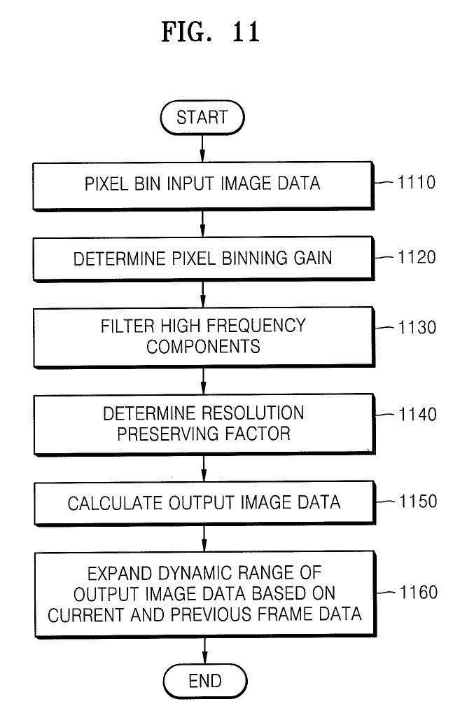

FIG. 11 is a flowchart illustrating a method of improving the sensitivity of an imaging apparatus according to another exemplary embodiment of the present invention.

In operation 1110, input image data is pixel binned to a predetermined pixel size.

In operation 1120, a pixel binning gain is calculated based on the input image data or the brightness of the input image data.

In operation 1130, high frequency components in a plurality of directions of the input image data are filtered.

In operation 1140, a resolution preserving factor is determined based on the high frequency components.

In operation 1150, output image data is calculated based on the pixel binned input image data, the pixel binning gain, the high frequency components, and the resolution preserving factor.

In operation 1160, the dynamic range of the output image data is expanded based on current frame data and previous frame data of the output image data.

The present invention may be embodied as computer readable codes on a computer readable recording medium. The computer readable recording medium is any data storage device that can store data which can be thereafter read by a computer system.

Examples of the computer readable recording medium include read-only memories (ROMs), random-access memories (RAMs), CD-ROMs, magnetic tapes, floppy disks, and optical data storage devices. The computer readable recording medium can be dispersively installed in a computer system connected to a network, and stored and executed as a computer readable code in a distributed computing environment.

As described above, the imaging apparatus and the method of improving the sensitivity of the imaging apparatus according to the exemplary embodiments of the present invention can expand the dynamic range of an image signal under low illumination conditions while preserving the resolution of input image data.

Furthermore, the imaging apparatus and the method of improving the sensitivity of the imaging apparatus according to the exemplary embodiments of the present invention can increase the signal to noise ratio under low illumination conditions.

While the present invention has been particularly shown and described with reference to the exemplary embodiments thereof, it will be understood by those of ordinary skill in the art that various changes in form and details may be made therein without departing from the spirit and scope of the present invention as defined by the following claims.

What is claimed is:

1. An imaging apparatus comprising:
a pixel binning unit that pixel bins input image data to a given pixel size;
a gain determining unit that determines a pixel binning gain based on the input image data or brightness of the input image data; and
a calculating unit that calculates output image data based on the pixel binned input image data and the pixel binning gain.

2. The imaging apparatus of claim 1, wherein the pixel binning unit preserves resolution of the input image data.

3. The imaging apparatus of claim 1, wherein the gain determining unit determines the pixel binning gain as a given maximum gain if the brightness of the input image data is less than a first threshold, and determines the pixel binning gain as a gain which linearly decreases from the given maximum gain as the brightness of the input image data increases, if the brightness of the input image data is greater than the first threshold.

4. The imaging apparatus of claim 1, wherein the calculating unit calculates the output image data by multiplying the pixel binned input image data by the pixel binning gain.

5. The imaging apparatus of claim 1, further comprising a temporal expansion unit that expands a dynamic range of the output image data based on current frame data and previous frame data of the output image data.

6. The imaging apparatus of claim 5, wherein the gain determining unit determines a data merge gain of the temporal expansion unit and provides the data merge gain to the temporal expansion unit.

7. An imaging apparatus comprising:
a pixel binning unit that pixel bins input image data to a given pixel size;
a high pass filtering unit that filters high frequency components in a plurality of directions of the input image data;
a resolution preserving factor determining unit that determines a resolution preserving factor based on the high frequency components; and
a calculating unit that calculates output image data based on the pixel binned input image data, the high frequency components, and the resolution preserving factor.

8. The imaging apparatus of claim 7, wherein the pixel binning unit preserves resolution of the input image data.

9. The imaging apparatus of claim 7, wherein the high pass filtering unit comprises:
a horizontal high pass filter that filters a first high frequency component in a horizontal direction of the input image data; and
a vertical high pass filter that filters a second high frequency component in a vertical direction of the input image data.

10. The imaging apparatus of claim 9, wherein the high pass filtering unit further comprises a diagonal high pass filter that filters a third high frequency component in a diagonal direction of the input image data.

11. The imaging apparatus of claim 10, wherein the resolution preserving factor determining unit:
obtains a maximum absolute value among absolute values of a difference between the first and the second high frequency components, a difference between the second and the third high frequency components, and a difference between the first and the third high frequency components;
determines the resolution preserving factor as a given minimum factor if the maximum absolute value is less than or equal to a second threshold;
determines the resolution preserving factor as a given maximum factor if the maximum absolute value is greater than or less than a third threshold; and
determines the resolution preserving factor as a gain which linearly increases as the maximum absolute value increases between the minimum given factor and the maximum given factor, if the maximum absolute value is between the second threshold and the third threshold.

12. The imaging apparatus of claim 11, wherein the calculating unit calculates the output image data by multiplying a sum of the high frequency components by the resolution preserving factor and adding the pixel binned input image data to the multiplication result.

13. The imaging apparatus of claim 7, further comprising a temporal expansion unit that expands a dynamic range of the output image data based on current frame data and previous frame data of the output image data.

14. A method of improving the sensitivity of an imaging apparatus, the method comprising:
pixel binning input image data to a given pixel size;
determining a pixel binning gain based on the input data or brightness of the input image data; and
calculating output image data based on the pixel binned input image data and the pixel binning gain.

15. The method of claim 14, wherein the pixel binning preserves resolution of the input image data.

16. The method of claim 14, wherein the pixel binning gain is determined as a given maximum gain if the brightness of the input image data is less than a first threshold, and is determined as a gain, which linearly decreases from the given maximum gain as the brightness of the input image data increases, if the brightness of the input image data is greater than the first threshold.

17. The method of claim 14, wherein the output image data is calculated by multiplying the pixel binned input image data by the pixel binning gain.

18. The method of claim 14, further comprising expanding a dynamic range of the output image data based on current frame data and previous frame data of the output image data.

19. A method of improving the sensitivity of an imaging apparatus, the method comprising:
pixel binning input image data to a given pixel size;
filtering high frequency components in a plurality of directions of the input image data;
determining a resolution preserving factor based on the high frequency components; and
calculating output image data based on the pixel binned input image data, the high frequency components, and the resolution preserving factor.

20. The method of claim 19, wherein the pixel binning preserves resolution of the input image data.

21. The method of claim 19, wherein the filtering of the high frequency components comprises:
filtering a first high frequency component in a horizontal direction of the input image data; and
filtering a second high frequency component in a vertical direction of the input image data.

22. The method of claim 21, wherein the filtering of the high frequency components further comprises filtering a third high frequency component in a diagonal direction of the input image data.

23. The method of claim 22, wherein the determining of the resolution preserving factor comprises:
obtaining a maximum absolute value among absolute values of a difference between the first and the second high frequency components, a difference between the second and the third high frequency components, and a difference between the first and the third high frequency components;
determining the resolution preserving factor as a given minimum factor if the maximum absolute value is less than or equal to a second threshold;
determining the resolution preserving factor as a given maximum factor if the maximum absolute value is greater than or equal to a third threshold; and
determining the resolution preserving factor as a gain, which linearly increases as the maximum absolute value increases between the minimum given factor and the maximum given factor, if the maximum absolute value is between the second threshold and the third threshold.

24. The method of claim 23, wherein the output image data is calculated by multiplying a sum of the high frequency components by the resolution preserving factor and adding the pixel binned input image data to the multiplication result.

25. The method of claim 19, further comprising expanding a dynamic range of the output image data based on current frame data and previous frame data of the output image data.
